(19) United States
(12) Patent Application Publication
(10) Pub. No.: US 2012/0067852 A1
(43) Pub. Date: Mar. 22, 2012

(54) REMOTE OUTPUT CONTROL FOR AN ELECTRIC WELDER POWER SUPPLY

(76) Inventors: Boyd BOSER, Sherwood Park (CA); Harold BOSER, Sherwood Park (CA)

(21) Appl. No.: 12/887,585

(22) Filed: Sep. 22, 2010

(51) Int. Cl. B23K 11/24

(52) U.S. Cl. 219/108

(57) ABSTRACT

A remote output control for controlling the output level of an electric welder power supply at a remote location and providing a source of isolated electrical power at the remote location is disclosed. The remote output control includes a water-proof, sealed housing fitted with an electrical receptacle and a potentiometer. A cable construction is electrically connected to the electrical receptacle and the potentiometer at one end and is provided with electrical plugs at the opposite end. A molded over wire y-adaptor is also included in the cable construction.

### FIELD OF THE INVENTION

The present invention relates generally to adjusting the output of an electric welder power supply, and more particularly, relating to wired remote output control for an electric welder power supply having an improved cable construction and an isolated auxiliary electrical power receptacle.

### BACKGROUND OF THE INVENTION

Electric welders include an electric power supply having a variable power output that is adjust according to various welding conditions, such as the material being welded. In some instances the electric power supply cannot be located in close proximity to the welder. In these instances the welder cannot easily make adjustments to output of the electric power supply during welding. Accordingly, various devices have been devised to permit the remote control of the of the electric welder power supply output. However, heretofore these devices have drawbacks. Additionally, there is a desire to a source of electrical power at the remote location for powering various electrical equipment such as lights, etc.

Accordingly, there is a need for a remote output control having an improved construction which overcomes the drawback of existing devices and which provides a source of electrical power at a remote location.

### SUMMARY OF THE INVENTION

Embodiments of the present invention addresses this need by providing a wired remote output control for remotely controlling the output of an electric welder power supply of an improved construction.

Embodiments of the present invention also provide an isolated supply of 110V electrical power at the remote output control housing.

Embodiments of the present invention also provide a cable construction that is water-proof and prevents corrosion of electrical connections and wires.

Embodiments of the present invention also provided a cable construction having molded of wire connections.

Embodiments of the present invention also provide a cable construction including a molded over wire Y-shaped adaptor.

Embodiments of the present invention also provide a cable construction that includes disconnects from the remote output control housing and the remote control port of an electric welder power supply.

Embodiments of the present invention also provide a cable construction having water-proof electrical couplings.

Embodiments of the present invention also provide single and multi-turn rotary potentiometers, or rheostat, for adjusting the power output of the electric welder power supply.

To achieve these and other advantages, in general, in one aspect, a remote output control for an electric welder power supply is provided. The remote output control includes a housing having a bottom wall, a top wall, and a sidewall extending continuously around and extending between the bottom wall and the top wall. The bottom wall, the top wall and the sidewall together defining an internal compartment. An electrical power receptacle is disposed within the internal compartment and extends through the sidewall. A rotary potentiometer is disposed within the internal compartment and has a control shaft extending through the top wall. A control knob is secured to the control shaft for turning the control shaft. A first length of insulated cable comprises a plurality of separately insulated wires. The electrical power receptacle is electrically connected to a first group of wires of the plurality of separately insulated wires. The rotary potentiometer is electrically connected to a second group of wires of the plurality of separately insulated wires. A second length of insulated cable comprises the first group of wires. A third length of insulated cable comprises the second group of wires. A molded y-connector conjoins the first length of insulated cable, the second length of insulated cable, and the third length of insulated cable. A first electrical plug is joined to an end of the second length of cable and is electrically connected to the first group of wires. The first electrical plug is configured for reception by an standard 110V electrical receptacle. A second electrical plug is joined to an end of the third length of cable and is electrically connected to the first group of wires. The second electrical plug is configured for connect to a remote control receptacle of the electric welder power supply.

In general, in another aspect, a remote output control for an electric welder power supply is provided. The remote output control includes housing having a bottom wall, a top wall, and a sidewall extending continuously around and extending between the bottom wall and the top wall. The bottom wall, the top wall and the sidewall together defining an internal compartment. An electrical power receptacle is disposed within the internal compartment and extends through the sidewall. A rotary potentiometer is disposed within the internal compartment and has a control shaft extending through the top wall. A control knob is secured to the control shaft for turning the control shaft. An electrical connection receptacle is disposed within said internal compartment and extends through said sidewall. The electrical power receptacle is electrically connected to said electrical connection receptacle. The rotary potentiometer is electrically connected to said electrical connection receptacle. A first length of insulated cable comprising a plurality of separately insulated wires. The plurality of separately insulated wires comprising a first group of wires and a second group of wires. A first electrical plug is joined to an end of said first length of insulated cable and is electrically connected to said first group of wires and said second group of wires. The first electrical plug is configured for reception by said electrical connection receptacle. A second length of insulated cable comprises said first group of wires. A third length of insulated cable comprises a said second group of wires. A molded y-connector conjoins said first length of insulated cable, said second length of insulated cable, and said third length of insulated cable. A second electrical plug is joined to an end of said second length of cable and is electrically connected to said first group of wires. The second electrical plug is configured for reception by an electrical power receptacle. A third electrical plug is joined to an end of said third length of cable and electrically connected to said first group of wires. The third electrical plug is configured for reception by a remote control receptacle of the electric welder power supply.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic perspective view of a remote output control for an electric welder power supply constructed in accordance with the principles of the present invention;

FIG. 2 is a top exploded view of the remote output control of FIG. 1;

FIG. 3 is a partial view of a cable assembly of the remote output control of FIG. 1;

FIG. 4 is a top exploded view of an alternative embodiment of a remote output control of FIG. 1; and

FIG. 5 is a partial view of a cable assembly of the remote output control of FIG. 4.

### DETAILED DESCRIPTION OF THE INVENTION

As a preliminary matter, it should be noted that in this document (including the claims) directional terms, such as “above”, “below”, “upper”, “lower”, etc., are used for convenience in referring to the accompanying drawings. Additionally, it is to be understood that the various embodiments of the invention described herein may be utilized in various orientations, such as inclined, inverted, horizontal, vertical, etc., without departing from the principles of the invention.

In this description, references to “one embodiment” or “an embodiment” mean that the featuring being referred to is included in at least one embodiment of the invention. Moreover, separate references to “one embodiment” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein.

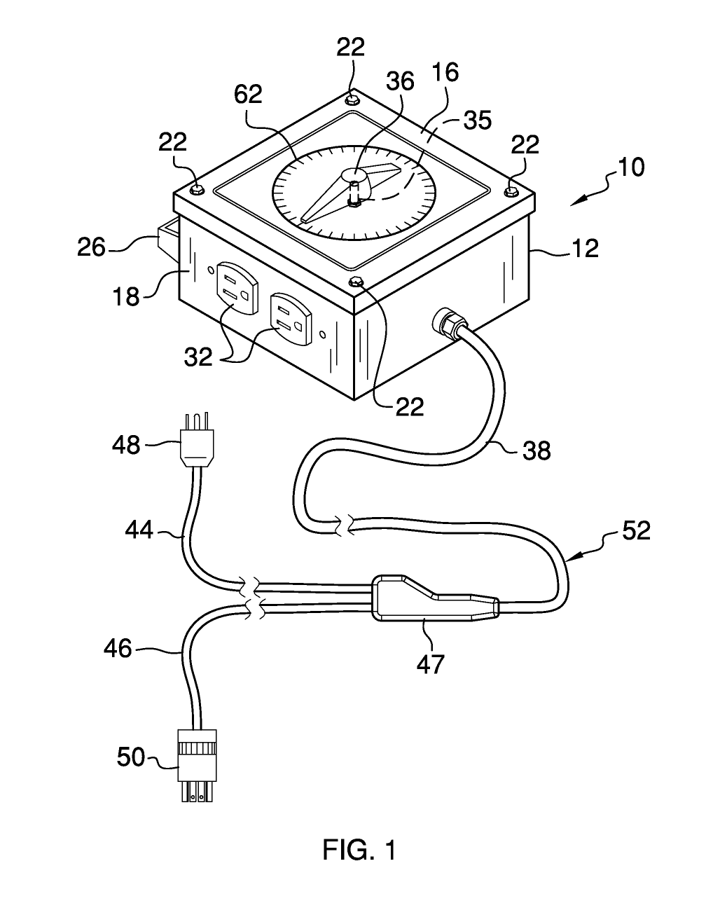

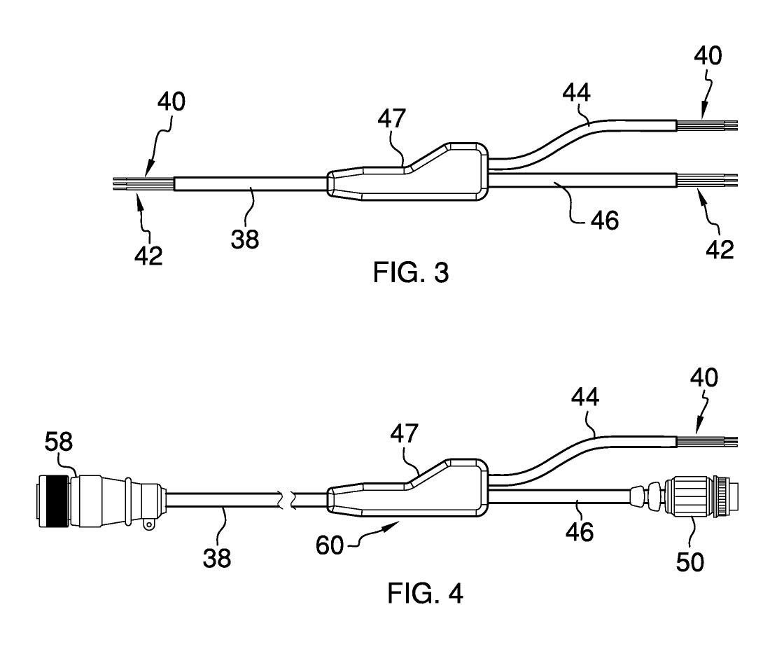

With reference now to the drawings, and in particular to FIGS. 1 through 5 thereof, a new remote output control for adjusting the output of an electric welder power supply embodying the principles and concepts of the present invention and generally designated by the reference numeral 10 will be described. The remote output control 10 provides the control of the power output of an electric welder power supply at a remote location from the electric welder power supply and a source isolated of electrical power at the remote location. The remote output control 10 is configured to be connected to a remote control port of an electric welder power supply and is operated to adjust the power output therefrom.

As best illustrated in FIGS. 1 through 3, the remote output control 10 generally comprises a housing 12 having a bottom wall 14, a removable top wall or cover 16 and a sidewall 18 extending between the bottom wall and the top wall, and an internal compartment 20. Cover 16 is removably attached to the housing 12 by a plurality of fasteners, such as screws 22 positioned at each corner that are threaded into flange 24. A water proofing seal 27 is disposed about the periphery of cover 16 and is engaged with flange 24 to seal the internal compartment 20 against water intrusion. A handle 26 extends from the sidewall 18 and provides a means for a user to grasp and position the housing 12.

An electrical power receptacle 28, such as a standard 110V electrical receptacle is disposed within the internal compartment 20 and extends through openings in the sidewall 18 positioning each receptacle 32 externally of the housing 12 permitting the connection of electrical power cords. As will become apparent below, receptacle 28 provides a source of auxiliary and isolated electrical power to an operator for the connection of electrical equipment to the remote output control 10, and thus eliminating the need for a separate extension cord.

A rotary potentiometer 34, or rheostat, is also disposed within the internal compartment 20 and has a control shaft 35 extending through the cover 16. The rotary potentiometer 34, or rheostat, is secured to the cover 16. In an embodiment, the rotary potentiometer 34, or rheostat, is a single turn rotary potentiometer. In an embodiment, the rotary potentiometer 34, or rheostat, is a mutli-turn rotary potentiometer. In an embodiment, the rotary potentiometer 34, or rheostat, is a three-turn rotary potentiometer. A control knob 36 is secured to the control shaft 35 for turning the control shaft. A dial 62 is disposed on cover 16 and arranged for cooperation with control knob 36 for adjusting the output of the electric welder power supply to which the remote output control 10 is connected.

The remote output control 10 further includes an insulated cable 38 including a first group of insulated wires 40 and a second group of insulated wires 42. The first group of insulated wires 40 comprise the standard three-wire group of a house hold 110V electrical connection, namely a hot wire, a neutral wire and a ground wire. The second group of insulated wires 42 comprise a plurality of wires configured for connection with the remote connection port of an electric welder power supply (not shown). The electrical power receptacle 28 is electrically connected to the first group of insulated wires 40. The rotary potentiometer 34, or rheostat, is electrically connected to the second group of insulated wires 42. At a distance along the length of cable 38, the cable is split into cables 44 and 46 at a molded over wire Y-adaptor 47. Cable 44 includes the first group of wires 40 and cable 46 includes the second group of wires 42.

A standard 110V male electrical plug 48 is joined to the end of cable 44 and is electrically connected to the first group of wires in a known manner. An electrical plug 50 is joined to the end of cable 46 and is electrically connected to the second group of wires in a desired configuration for connection to the remote connection port of an electric welder power supply. Plug 50 is configured to be received by the remote connection port of the electric welder power supply. Plugs 48 and 50 can be of the molded over wire type ensuring a water tight seal with cables 44 and 46, respectively.

The cable assembly 52 comprised of cable 38, Y-adaptor 47, cables 44 and 46, and plugs 48 and 50 is constructed to be water-proof to prevent the intrusion of moisture and water along the entire length of the cable assembly, thereby prevent corrosion of the electrical connections and wires.

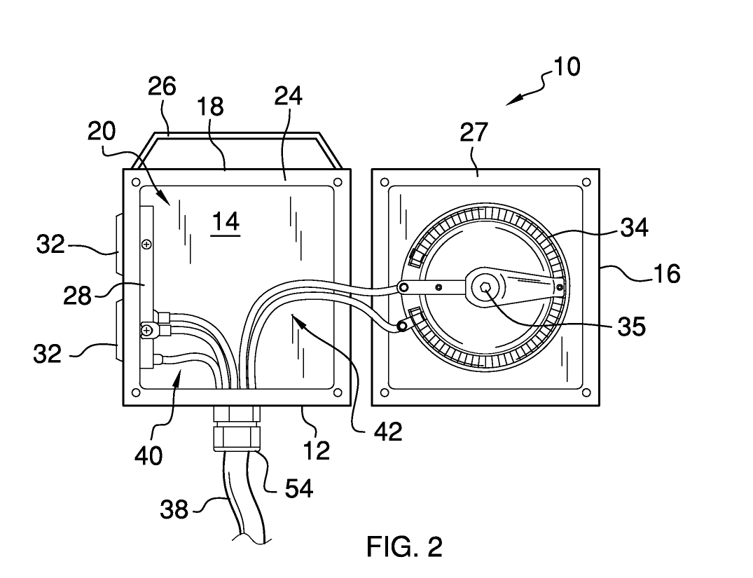

As best seen in FIG. 2, cable 38 is secured to the housing 12 by a compression fitting 54 preventing water and moisture intrusion through the sidewall 18 around cable 38. Compression fitting 54 prevents the disconnection of cable 38 from the housing 12. In some instances it is desirable to disconnect cable 38 from the housing to permit the cable to be threaded through tight spaces that the housing 12 will not pass through.

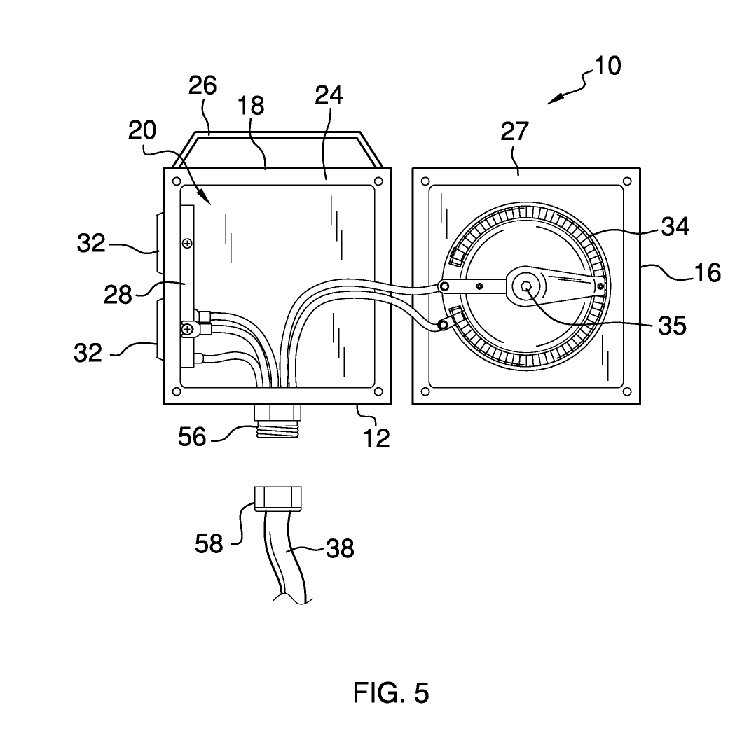

In FIGS. 4 and 5, an embodiment of the remote output control 10 is illustrated having a twist lock receptacle 56 and a cooperative twist lock plug 58. Twist lock receptacle 56 is disposed within internal compartment 20 and extends through the sidewall 18. The twist lock plug 58 is joined to the end of cable 38 and is electrically connected to the first and second groups of wires 40 and 42. The twist lock receptacle 56 is electrically connected to the electrical power receptacle 28 and the rotary potentiometer 34, or rheostat, in a configuration such that when the twist lock plug 58 is connected to the twist lock receptacle 56, the first group of wires 40 is electrically connected to the electrical power receptacle and the second group of wires 42 is electrically connected to the rotary potentiometer, or rheostat. The twist lock receptacle 56 and plug 58 pair provided a water-tight disconnect between cable 38 and the housing 12. Twist lock receptacle 56 and plug 58 may be Amphenol connectors. In this manner cable assembly 60 is provided including twist lock plug 58, cable 38, Y-adaptor 48, cables 44 and 46, and plugs 48 and 50 as a separate assembly that can be threaded or run through tight spaces that the housing will not pass through. Like cable assembly 52, cable assembly 60 is constructed to be water-proof to prevent the intrusion of moisture and water along the entire length of the cable assembly, thereby prevent corrosion of the electrical connections and wires.

A number of embodiments of the present invention have been described. Nevertheless, it will be understood that various modifications may be made without departing from the spirit and scope of the invention. Accordingly, other embodiments are within the scope of the following claims.

What is claimed is:

1. A remote output control for an electric welder power supply, comprising:
a housing having a bottom wall, a top wall, and a sidewall extending continuously around and extending between said bottom wall and said top wall, said bottom wall, said top wall and said sidewall together defining an internal compartment;
an electrical power receptacle disposed within said internal compartment and extending through said sidewall;
a rotary potentiometer disposed within said internal compartment and having a control shaft extending through said top wall;
a control knob secured to said control shaft for turning said control shaft;
a first length of insulated cable comprising a plurality of separately insulated wires;
said electrical power receptacle electrically connected to a first group of wires of said plurality of separately insulated wires;
said rotary potentiometer electrically connected to a second group of wires of said plurality of separately insulated wires;
a second length of insulated cable comprising said first group of wires
a third length of insulated cable comprising a said second group of wires;
a molded y-connector conjoining said first length of insulated cable, said second length of insulated cable, and said third length of insulated cable;
a first electrical plug joined to an end of said second length of cable and electrically connected to said first group of wires, said first electrical plug configured for reception by an electrical receptacle; and
a second electrical plug joined to an end of said third length of cable and electrically connected to said first group of wires, said second electrical plug configured for reception by a remote control receptacle of the electric welder power supply.

2. The remote output control of claim 1, wherein said rotary potentiometer is a multi-turn rotary potentiometer.

3. A remote output control for an electric welder power supply, comprising:
a housing having a bottom wall, a top wall, and a sidewall extending continuously around and extending between said bottom wall and said top wall, said bottom wall, said top wall and said sidewall together defining an internal compartment;
an electrical power receptacle disposed within said internal compartment and extending through said sidewall;
a rotary potentiometer disposed within said internal compartment and having a control shaft extending through said top wall;
a control knob secured to said control shaft for turning said control shaft;
an electrical connection receptacle disposed within said internal compartment and extending through said sidewall;
said electrical power receptacle electrically connected to said electrical connection receptacle,
said rotary potentiometer electrically connected to said electrical connection receptacle;
a first length of insulated cable comprising a plurality of separately insulated wires, said plurality of separately insulated wires comprising a first group of wires and a second group of wires;
an first electrical plug joined to an end of said first length of insulated cable and electrically connected to said first group of wires and said second group of wires, said first electrical plug configured for reception by said electrical connection receptacle;
a second length of insulated cable comprising said first group of wires
a third length of insulated cable comprising a said second group of wires;
a molded y-connector conjoining said first length of insulated cable, said second length of insulated cable, and said third length of insulated cable;
a second electrical plug joined to an end of said second length of cable and electrically connected to said first group of wires, said second electrical plug configured for reception by an electrical power receptacle; and
a third electrical plug joined to an end of said third length of cable and electrically connected to said first group of wires, said third electrical plug configured for reception by a remote control receptacle of the electric welder power supply.

4. The remote output control of claim 3, wherein said rotary potentiometer is a multi-turn rotary potentiometer.

5. The remote output control of claim 3, wherein said electrical connection receptacle is of the twist lock type, and wherein said first electrical plug is of the twist lock type.

6. The remote output control of claim 3, wherein said y-connector is molded over said first length of insulated cable, said second length of insulated cable, and said third length of insulated cable.
